(19) United States
(12) Patent Application Publication
(10) Pub. No.: US 2003/0090083 A1
(43) Pub. Date: May 15, 2003

(54) Supplemental trailer hitch for backing

(76) Inventor: Ronald G. Williams, Federal Way, WA (US)

Correspondence Address: LAW OFFICE OF DAVID L. TINGEY, 321 BURNETT AVE. S., STE 303, RENTON, WA, 98055, US

(21) Appl. No.: 10/008,350

(22) Filed: Nov. 13, 2001

(51) Int. Cl. B60D 1/24

(52) U.S. Cl. 280/460.1

(57) ABSTRACT

A removable supplementary hitch pivots into operational position on a trailer tongue in concert with a primary trailer hitch of the dependent vehicle used in pulling the trailer. The secondary hitch includes at least one additional hitch between the trailing vehicle and the dependent vehicle. Another additional hitch is also commonly provided resulting in an additional hitch on either side of the primary hitch. To introduce a measure of tolerance to breaking the connection through unwanted turning of the power vehicle after the secondary hitch is attached between the vehicles, the connection between the bar and the channel may comprise a flexible spring connection that allows the bar to move off parallel to the channel in absorbing unwanted turning forces while biasing the bar to return to its parallel position.

### BACKGROUND OF THE INVENTION

1. Field of the Invention.

This invention relates to trailer hitches, and more specifically, to a supplemental trailer hitch complementing a primary trailer hitch which when employed together establish a nonbending connection between the trailer and a pulling vehicle.

2. Prior Art.

It is well known to have a primary trailer hitch on a forward end of a trailer tongue for connecting the trailer to its pulling vehicle. The hitch is commonly a ball socket on the trailer establishing an articulated connection between the trailer and the pulling vehicle. Thus, when the pulling vehicle turns, so does the trailer with a bend between them through the hitch. This configuration works well during forward motion. But for the less experienced driver, backing the combination sometimes proves difficult. A common maneuver is to back a trailer straight, such as when unloading a boat into a lake. The trailer is backed straight down a ramp until the boat on the trailer is afloat in the water. With the typical articulated connection, it is not uncommon to witness a driver several times attempting to back his trailer down a narrow boat ramp only to have the trailer turn.

### SUMMARY OF INVENTION

A first object is to provide a trailer hitch that restrains a trailer from turning off course from a straight backing direction of a pulling vehicle when the pulling vehicle is backed (thus becoming a pushing vehicle). Another object is to provide a firm, nonpivoting connection between the pulling vehicle and the trailer. A further object is to convert a pivoting connection, such as the traditional ball and socket hitch, to a nonpivoting connection. Still another object is to provide a nonpivoting connection that is tolerant to unwanted small turning of the pulling vehicle.

These objects are achieved in a removable secondary hitch mounted together with the primary, typically ball and socket, hitch on the tongue of the dependent vehicle. The secondary hitch includes at least one additional hitch between the trailer and the pulling vehicle. Another additional hitch is also commonly provided resulting in an additional hitch on either side of the primary hitch.

Typically, the primary hitch comprises a trailer tongue extending forward of the trailer with a ball socket on its tongue forward end. The secondary hitch comprises an extended channel that is secured in nonslidable place over the trailer tongue. A first bar is connected to the channel in parallel. The first bar is then connected to the pulling vehicle either with a ball socket engaging a second ball hitch secured to the pulling vehicle off center or a rectangular tube receiving the first bar therein. Thus the two points of connection between the vehicles prevent one vehicle from turning relative to the other. When the power vehicle is backed with both hitches connected between the vehicles, they move as a combined single vehicle straight backward.

Similarly, for strength and redundancy, the secondary hitch may also comprise a second bar also tied to the tongue in parallel and similarly secured to the pulling vehicle off center with the first and second bars on opposite sides of the trailer tongue in parallel with a longitudinal axis transversely central to the pulling vehicle and passing through the primary ball and socket hitch.

With both hitches connecting the vehicles, it is advisable to lock the steering wheel of the power vehicle with wheels directed parallel to the vehicle axis. Otherwise, if the wheel is turned off-axis, intentionally or inadvertently, a force develops on the connection between the parallel bars and the channel that is likely to break the connection. To introduce a measure of tolerance to such a break, the connection between the bar and the channel may comprise one or more springs that allows the bar to move off of parallel to the channel. To not defeat the purpose of establishing a firm second connection between the vehicles, the spring remains nearly rigid, but able to absorb the unwanted force prior to the connection breaking and destroying the hitch. It also resiliently biases the bar to return to its parallel position.

### BRIEF DESCRIPTION OF THE DRAWINGS

FIG. 1 is a perspective view of the supplemental hitch of the present invention showing a connection on each side of a central channel in operational position behind a pulling vehicle.

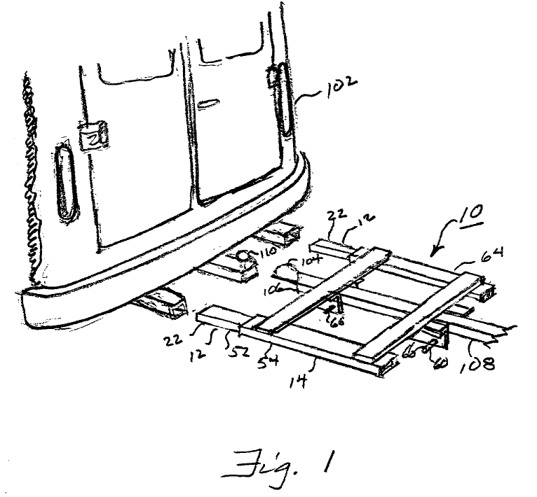

FIG. 2 is a perspective view of the supplemental hitch of FIG. 1 shown in its storage position.

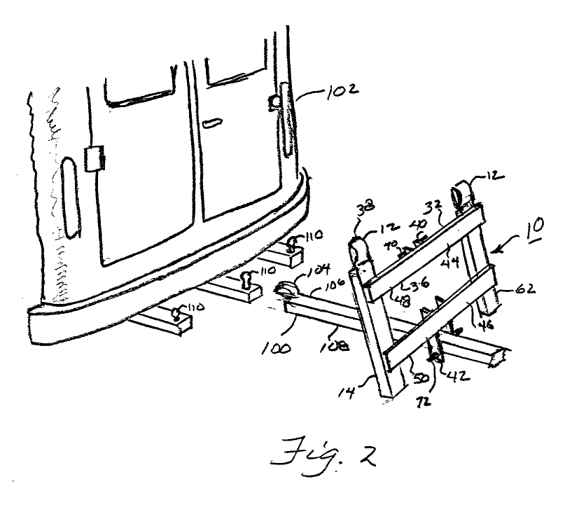

FIG. 3 is a perspective view of the supplemental hitch of FIG. 1 showing resilient springs biasing side bars parallel to the central channel that fits over a trailer tongue.

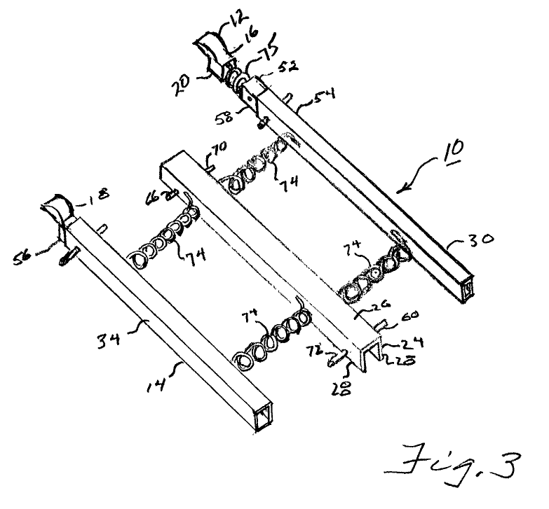

FIG. 4 is a perspective view of the supplemental hitch of the present invention showing a single bar with hitch to the side of the central channel.

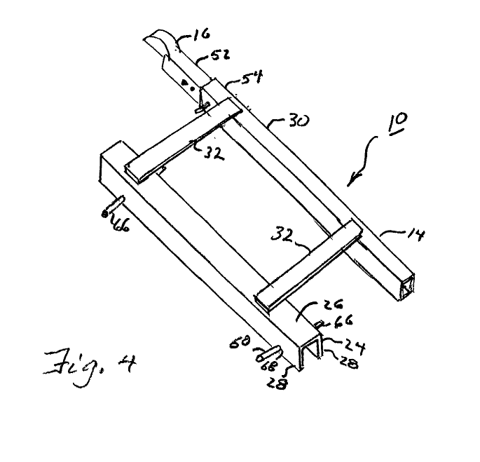

FIG. 5 is a perspective view of the supplemental hitch of FIG. 4 shown with a resilient spring biasing the bar parallel to the central channel.

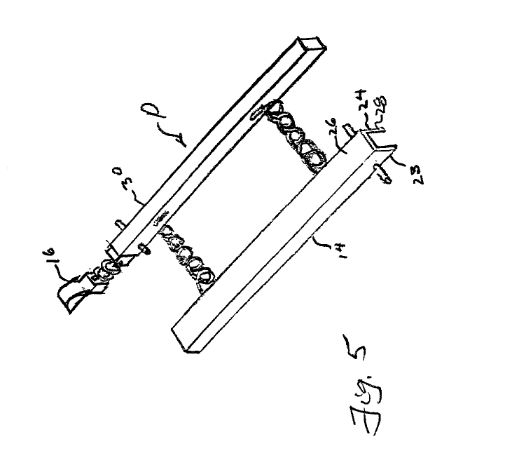

### DETAILED DESCRIPTION OF THE PREFERRED EMBODIMENT

The present invention comprises a supplemental trailer hitch 10 functioning in concert with a first, or primary, trailer hitch 100 to link a trailer with a pulling vehicle 102 as a single unit. Linked with these two connection points, they do not turn relative to each other during a backing maneuver.

Typically, the primary trailer hitch 100 through which the pulling vehicle pulls the trailer, commonly a ball socket 104, is located on the distal, forward end 106 of a trailer tongue 108, transversely central between the pulling vehicle and the trailer. The ball socket 104 receives a hitch ball 110 mounted on the pulling vehicle 102. The supplemental trailer hitch 10 comprises one or more additional hitches 12 on a frame 14 fitting over the trailer tongue 108. In a first configuration, a second trailer hitch 16 is mounted on one side of the trailer tongue 108. In a second configuration, a third trailer hitch 18 may be mounted on the other side of the tongue 108. The supplemental hitches may comprise a ball socket hitch 20 similar to the primary hitch, or they may comprise an extending rod 22 received into matching tubes 112 on the pulling vehicle.

The supplemental hitch frame 14 comprises an inverted U-shaped channel 24 including a web 26 separating parallel sides 28 depending therefrom, adapted to rest over the trailer tongue 108 therein preventing lateral movement of the channel on the tongue member.

A bar 30 parallels the channel 24 on one side with a connecting member 32 joining the bar 30 and the channel 24 with the trailer hitch forward on the bar 30 and adapted to engage a pulling vehicle hitch 114. For a third hitch 18 on the other side of the primary hitch, another bar 34 similarly parallels the channel 24 on the other side with another connecting member 36 joining the bar 34 and the channel 24 with an additional trailer hitch 38 again forward on the bar 30 and adapted to engage another pulling vehicle hitch 114. For example, one supplemental hitch might be right of the primary hitch and another might be to its left. (Right and left references are for convenience of description only and should be understood to be interchangeable without functional effect. Usually, the channel 24 comprises aligned forward and rearward channel members 40 and 42, and the connecting member 32 includes forward and rearward connecting members 44 and 46 respectively connecting the bar 30 to the forward and rearward channel members 36 and 38. Similarly, for the third hitch configuration, the other connecting member 36 similarly includes forward and rearward connecting members 48 and 50 respectively connecting the other bar 34 to the forward and rearward channel members also.

The bar 30 and the other bar 34 comprise a bar member 52 telescoping from another bar member 54 so the bar can be extended between a bar retracted position 56 during general vehicle travel when the supplemental hitches are not connected to the pulling vehicle and an engagement position 58 when the supplemental hitch is connected to the pulling vehicle preparatory for straight backing. When the supplemental hitch is not in use, it pivots on a pivoting member 60 to a storage position 62 with the channel 24 raised off of the tongue 108. When the supplemental hitch is employed, it is lowered from its storage position 62 to its operational position 64 with the channel 24 over the tongue 108. When pivoted into operational position 64, a releasable locking pin 66 passes through opposing holes 68 in the channel sides 28 below the trailer tongue 108 securing the channel 24 to the trailer tongue 108. Typically, a forward pin 70 is employed in the forward channel member 40 and a rearward pin 72 is employed in the rearward channel member 42. Thus configured, the rearward pin 42 also functions as the pivot pin on which the supplemental hitch rotates between its operational and storage positions.

To tolerate small, inadvertent turns of the pulling vehicle during backing, in an alternative embodiment the connecting members 32 and 36 may comprise one or more resilient springs 74 between the bars 30 and 34 and the channel 24 that bias the bars into a position parallel with the channel but compresses or extends to absorb forces that would otherwise break the hitch. Further, bar 30 may comprise a resilient spring 75 between the ball socket hitch 20 and joinder of the connecting member 32 to the bar 30 to similarly absorb unwanted turning forces. In such a configuration, the supplemental hitch includes a socket 20 for connection to a hitch ball 110 on the pulling vehicle that allows the supplemental hitch to slightly rotate as the spring 74 absorbs inadvertent turning forces. An alarm may be employed in concert with the spring to alert a driver to correct the inadvertent turn.

Having described the invention, what is claimed is as follows:

1. A trailer hitch comprising
a first, or primary, trailer hitch forward on a forward-extending tongue of a trailer for removably engaging a matching primary vehicle hitch rearward on a pulling vehicle, and
a second trailer hitch also on the trailer tongue also disposed to engage a matching second vehicle hitch on the pulling vehicle, the two hitches between the trailer and the pulling vehicle establishing an unbending connection between the trailer and the pulling vehicle effectively combining the trailer and the pulling vehicle into a single vehicle without relative movement between them.

2. The trailer hitch of claim 1 wherein the second trailer hitch comprises
a first bar member,
a second bar member telescoping from the first bar member between a bar retracted position in the first bar member with the bar retracted into the bar second member and an engagement position with the second hitch disposed to engage the matching second vehicle hitch.

3. The trailer hitch of claim 1 further comprising a third hitch opposite the second hitch from the primary hitch.

4. The trailer hitch of claim 1 further comprising
a ball socket on the first trailer hitch disposed to engage a first ball hitch on the pulling vehicle, and
a ball socket on the second hitch disposed to engage a second ball hitch on the pulling vehicle.

5. A supplemental trailer hitch complementing a primary hitch of a trailer on a trailer tongue located transversely central at the trailer front, comprising
an inverted U-shaped channel including a web separating parallel sides depending therefrom, adapted to rest over a trailer tongue member preventing lateral movement of the channel on the tongue member,
a right bar parallel to the channel,
a right connecting member joining the right bar and the channel,
a right trailer hitch member forward on the right bar and adapted to engage a right pulling vehicle hitch member.

6. The supplemental trailer hitch of claim 5 wherein the right trailer hitch member comprises an extendable rod receivable into a matching pulling vehicle tube.

7. The supplemental trailer hitch of claim 5 further comprising a lock releasably securing the channel to the trailer tongue.

8. The supplemental trailer hitch of claim 5 further comprising a pivoting member on which the supplemental trailer hitch pivots from a storage position with the channel off of the tongue to an operational position with the channel over the tongue.

9. The supplemental hitch of claim 5 further comprising a
a left bar parallel to the channel and opposite the right bar from the channel therebetween,
a left connecting member joining the left bar and the channel,
a left trailer hitch member forward on the left bar and adapted to engage a left pulling vehicle hitch member.

10. The supplemental trailer hitch of claim 5 wherein the right connecting member comprises a resilient member adapted to bias the right bar into a position parallel with the channel.

11. The supplemental trailer hitch of claim 10 wherein the resilient member comprises a spring between the right bar and the channel.

12. The supplemental trailer hitch of claim 11 further comprising a ball socket on the right trailer hitch disposed to engage a ball hitch on the pulling vehicle.

13. The supplemental hitch of claim 5 wherein the channel comprises forward and rearward channel members and the right connecting member includes right forward and rearward connecting members respectively connecting the right bar to the forward and rearward channel members.

14. The supplemental hitch of claim 5 wherein the channel comprises forward and rearward channel members and the right connecting member includes right forward and rearward connecting members respectively connecting the right bar to the forward and rearward channel members and the left connecting member includes left forward and rearward connecting members respectively connecting the left bar to the forward and rearward channel members.

15. A supplemental trailer hitch complementing a primary hitch of a trailer on a trailer tongue located transversely central at the trailer front, comprising
an inverted U-shaped forward and rearward channel members aligned longitudinally,
a right bar parallel to the channel members, adapted to rest over a trailer tongue member preventing lateral movement of the channel on the tongue member,
a left bar parallel to the channel and opposite the right bar from the channel therebetween,
right forward and rearward connecting members respectively connecting the right bar to the forward and rearward channel members,
left forward and rearward connecting members respectively connecting the left bar to the forward and rearward channel members,
a right trailer hitch member forward on the right bar and adapted to engage a right pulling vehicle hitch member,
a left trailer hitch member forward on the left bar and adapted to engage a left pulling vehicle hitch member,
a pivoting member on which the supplemental trailer hitch pivots from a storage position with the channel members off of the tongue to an operational position with the channel members over the tongue,
a lock releasably securing a channel member to the trailer tongue in the operational position.

16. The supplemental trailer hitch of claim 15 further comprising a ball socket on the right trailer hitch disposed to engage a ball hitch on the pulling vehicle and wherein the right connecting member comprises a spring between the right bar and the channel biasing the right bar into a position parallel with the channel.

17. The supplemental trailer hitch of claim 5 wherein the bar further comprises a resilient member adapted to absorb unwanted turning forces.

18. The supplemental trailer hitch of claim 10 wherein the resilient member comprises a spring between the right connecting member and the right trailer hitch member.
